(19) United States
(12) Patent Application Publication
(10) Pub. No.: US 2025/0227134 A1
(43) Pub. Date: Jul. 10, 2025

(54) INTERACTIVE POINT-OF-VIEW VIDEO SERVICE

(71) Applicant: Mirza MUFTIC, Zagreb (HR)

(72) Inventors: Mirza MUFTIC, Zagreb (HR); Vedran VUKMAN, Zagreb (HR)

(21) Appl. No.: 19/088,186

(22) Filed: Mar. 24, 2025

Related U.S. Application Data
(63) Continuation-in-part of application No. 14/688,856, filed on Apr. 16, 2015, now Pat. No. 12,262,088.
(60) Provisional application No. 61/980,517, filed on Apr. 16, 2014.

(51) Int. Cl. H04L 65/1089; G06F 3/0482; H04L 65/1069; H04L 65/403; H04N 23/661

(52) U.S. Cl. CPC H04L 65/1089; G06F 3/0482; H04L 65/1069; H04L 65/403; H04N 23/661

(57) ABSTRACT

A system, an apparatus and a method for an interactive point of-view video service are disclosed. In an embodiment, a method includes selecting, from a remote location, an electronic device to capture a point-of-view (POV) video of an event and controlling, from the remote location, the electronic device as the electronic device captures the POV video.

### TECHNICAL FIELD

A system, an apparatus and a method for an interactive point of-view video service are disclosed. In an embodiment, a method includes selecting, from a remote location, an electronic device to capture a point-of-view (POV) video of an event and controlling, from the remote location, the electronic device as the electronic device captures the POV video.

### BACKGROUND

Some current electronic devices (e.g., an optical head-mounted display (OHMD) or some other similar type device) can record video for streaming or for storage within the electronic device for upload to a computer. The electronic device it typically worn by the person recording the video while a viewer of the video passively watches the video from a remote location. Often, the time between the recording of the video and the time the video is watched can be hours or even days.

### SUMMARY

In accordance with a preferred embodiment of the present invention, a method comprises selecting, from a remote location, an electronic device to capture a point-of view (POV) video of an event and controlling, from the remote location, the electronic device as the electronic device captures the POV video.

### BRIEF DESCRIPTION OF THE DRAWINGS

Embodiments are illustrated by way of example and not by way of limitation in the FIGURES of the accompanying drawings, in which like references indicate similar elements and in which:

FIG. 1 is a simplified block diagram illustrating an embodiment of a portion of an interactive point-of-view video service, in accordance with one embodiment of the present disclosure;

FIG. 2 is a simplified schematic diagram illustrating an embodiment of an electronic device in a closed clamshell configuration, in accordance with one embodiment of the present disclosure;

FIG. 3 is a schematic diagram showing a transmission path between a user and a streamer, in accordance with one embodiment of the present disclosure;

FIG. 4 is a flow diagram showing a process of users sequentially controlling a streamer, in accordance with one embodiment of the present disclosure;

FIG. 5 is a simplified block diagram illustrating another embodiment of a portion of an interactive point-of-view video service, in accordance with one embodiment of the present disclosure;

FIG. 6 a simplified block diagram illustrating a search interface, in accordance with one embodiment of the present disclosure;

FIGS. 7A and 7B are exemplary views of streamer search interfaces, in accordance with one embodiment of the present disclosure;

FIG. 8 is an exemplary view of a streamer transmitting method selection interface, in accordance with one embodiment of the present disclosure; and

FIG. 9 is a user control communication method selection interface, in accordance with one embodiment of the present disclosure.

### DETAILED DESCRIPTION OF ILLUSTRATIVE EMBODIMENTS

In today's busy world, sometimes a person needs to be in two (or more) places at the same time. Other times, a person may need to travel to a location just to see or observe something or someone. Often, travel to the location can be expensive (travel fares, travel expenses, etc.), time consuming, and reduce productivity. In addition, in the sale of goods, travel to the customer (or the customer traveling to the point-of-sale) is often required, as customers are often not engaged when they are a distance away from the point of sale. What is needed is a service where a person can create a live point-of-view (POV) event and users or customers can experience the event.

In one example embodiment, a POV service can be configured for streaming live POV video from a streamer to a user and allow for two-way audio communication between the streamer and the user. The POV video may be one-way video from the streamer to the user. The streamer can be equipped with an optical head-mounted display (OHMD), a streaming video camera, wearable video camera, or some other similar type device that can provide video and/or audio to the user. The term “streamer” includes a person in the real world (or an extension of the person) streaming POV video of an event (e.g., a person or individual wearing an OHMD and streaming POV video of an event). The streamer can be similar to a live human avatar. A user can see what the streamer sees and hear what the streamer hears. During a POV event, a user can control the streamer's actions using voice commands, digital cues or prompts, or some other means for controlling the streamer's actions. For example, when using voice commands, a user may instruct a streamer to pick up an object, look at a building, walk over to the edge of a street, etc.

A user interface can be configured to allow users or companies to create or participate in a live POV event with one or more streamers creating POV video and participating or interacting with the users. The POV event can be located in almost any environment or geographical location. The POV event may be of any sort of event or service that can be live streamed such as an educational event, social event, gaming event, tutoring service, point of sale service, etc. as well as many different business uses (e.g., point-of-sale event, real estate, remote repairs, construction, shopping, etc.). The event can be selected or setup by a user and the user can choose which streamer (if more than one streamer is available for the event) will be controlled by the user. The POV event can last almost any amount of time and the cost for the POV even may be calculated per minute, per hour, free, etc.

In one example, the POV video can be streamed to many users. If the POV video is streamed to many users, one user may be authorized to have audio communication with the streamer and control the streamer. In another example, only a select few authorized users may have audio communication with the streamer. The other users who do not have authorization are without the privilege or ability to command the streamer. In some examples, the privilege or authorization to command the streamer may be changed or passed from one user to another during a POV event.

The interactive POV service can be configured to offer both parties (streamers and users) convenience and profit. Streamers can utilize whatever POV streaming hardware they own to “sell” their time, talent, and expertise to POV events. Users on the other end, experience these sessions in an “as if they were there” kind of experience and can save money by reducing travel expenses, increasing productivity, etc.

At the user interface, customers can sign-up and choose if they want to be streamers or users, or both. Numerous filters can allow a user to browse through content, type of event, specific type of streamer, etc. and choose specific events, places, streamers, etc. At the user interface, various POV events can be organized as top free POV events, top paid POV events, featured POV events, assistants for hire, etc. The user interface can also allow the user to make future appointments for streamers.

The POV service can be used to create live events of almost any kind. In a specific example, a live poker game with 8 streamers (with POV cameras) siting at a poker table can be created. Each streamer can be controlled by a user from anywhere in the world. The real people, real cards, and a real poker room allow the user to play poker as if they were there in person.

To illustrate a business application, sales personnel may be equipped with POV cameras and the sales people may be streamers. By using sales people as streamers, users that do not feel like going to a showroom can experience the store and consumer products as if they were there in person. For example, if the consumer product was a car, a user could sit on their couch and instruct a streamer to go over to a red car, pop the trunk, sit inside, open the glove compartment, and so on. Such an experience could engage the customer (user) in a unique and personalized way.

Features in the following figures, such as structure(s), function(s), and/or characteristic(s) for example, are described with reference to one example as a matter of convenience; various examples may be implemented with any suitable one or more described features or with other features.

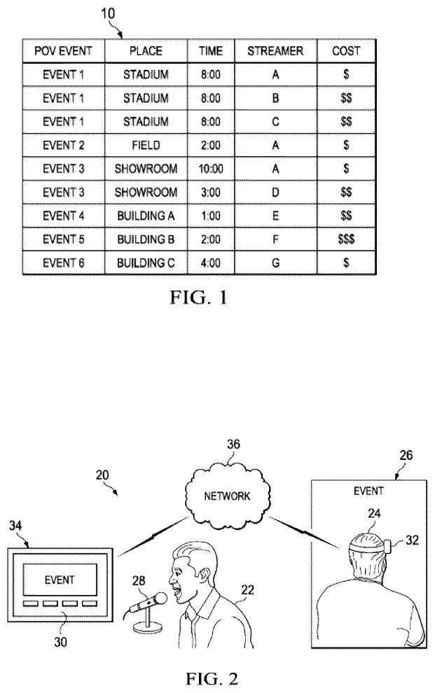

FIG. 1 is a simplified diagram illustrating an example of a user interface 10 that can be used to select a POV event. User interface 10 can be configured to display information related to one or more POV events. For example, as illustrated in FIG. 1, user interface 10 may display available events (or only one event), places for the events, times for the events, any streamers available for the events, and the cost for a POV video of the event. Other types of information may be displayed or the illustrated information may be displayed differently. A user can view the information and select a POV event they wish to participate.

Turning to FIG. 2, FIG. 2 is an illustrative example of one aspect of POV service 20. As illustrated in FIG. 2, a user 22 is participating in a POV event 26 through a streamer 24 wearing a streaming video camera 32. User 22 can control streamer 24 using a user interface 30 on a remote device 34. User 22 and streamer 24 can be connected through a network 36. In a specific example, user interface 30 can be connected to a microphone 28 and microphone 28 can allow user 22 to communicate commands to streamer 24 such that user can interact with POV event 26 using streamer 24 and user interface 30.

POV service 20 can serve as a link between streamer 24 (e.g., people, extensions, individuals, etc. wearing a head mounted camera and streaming their POV video) and user 22 (e.g., people that see what the streamers see, hear what they hear and at the same time control the actions of the streamers) and allow user 22 to be at two or more places at the same time. POV service 20 can also include a platform (e.g., user interface 10 or 30) where streamers can set-up their POV streams of an event and users can experience and participate in the event. Streamers can hold POV courses in cooking, painting, math, etc. or be live POV personal assistants for hire. The possible applications are virtually limitless. POV service 20 can also allow streamers to create and publish interactive POV events on an interactive user interface (e.g., user interface 10 or 30), choose if they want to be controlled by a single user, or just stream their POV video to many users. Streamers can set a price for those sessions on a per-minute, hour, etc. basis. In one implementation, when a specific business wants to use a streamer, the business can go through a customized user interface configured for the specific business.

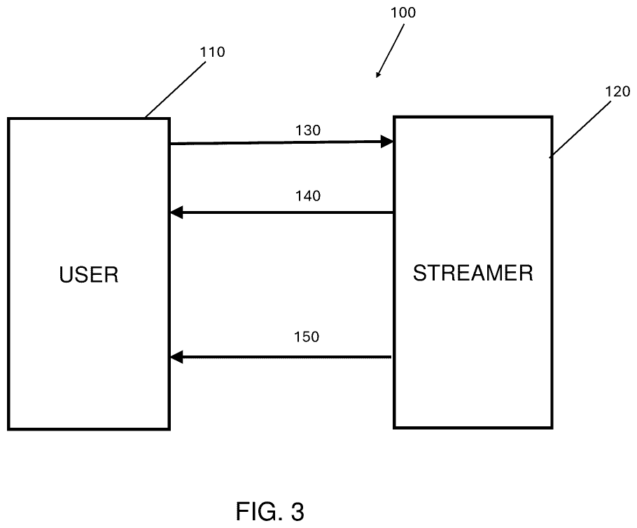

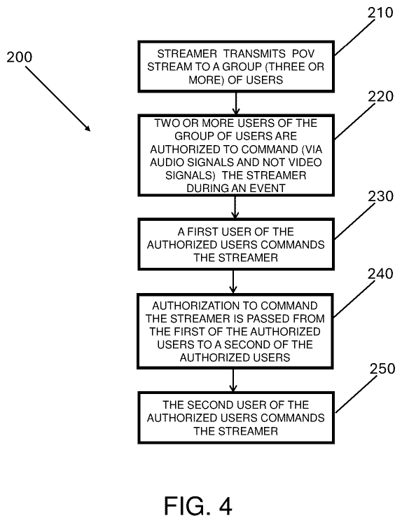

With reference to FIG. 3, there is shown a simplified schematic drawing showing transmissions between the user (at a first electronic device 110) and a streamer (at a second electronic device 120). As discussed above, the user can communicate with and control the actions of the streamer via direct two-way audio communications. In such a configuration, the user can directly provide audio control instructions 130 communicate to the streamer, and the streamer can provide a direct audio response 140 to the user. By direct communications, it is meant that the user and the streamer are communicating directly with each other without a third person being in the line of communication. However, as shown in FIG. 2, direct communication does include the communication being routed through Internet or cloud communications. The streamer also provides a POV video stream 150 from the second electronic device 120 to the user at the first electronic device 110.

With reference to FIG. 2, there is shown a process flow 200 for sharing of control of a streamer among various users of the streaming service, in view of one embodiment of the invention. In step 210, the streamer transmits a POV stream to a group (e.g., three or more) of users 22. In step 220, a subset (i.e., two) of the total users 22 viewing the stream have authorization to control the actions of the streamer via audio (not video) transmission during the steaming event. In step 230, a first user 22 of the authorized users 22 controls the streamer during the streaming event. Then, in step 240, authorization to command the streamer is passed from the first of the authorized users 22 to a second of the authorized users 22. Next, in step 250, the second user 22 of the authorized users controls the actions of the streamer.

Thus, by way of this embodiment of the invention, i) a POV video can be streamed to many users, ii) a few (i.e., two or more) authorized users of the many users have audio communication with the streamer, and iii) the authorization to command the streamer can be passed from one user to another user.

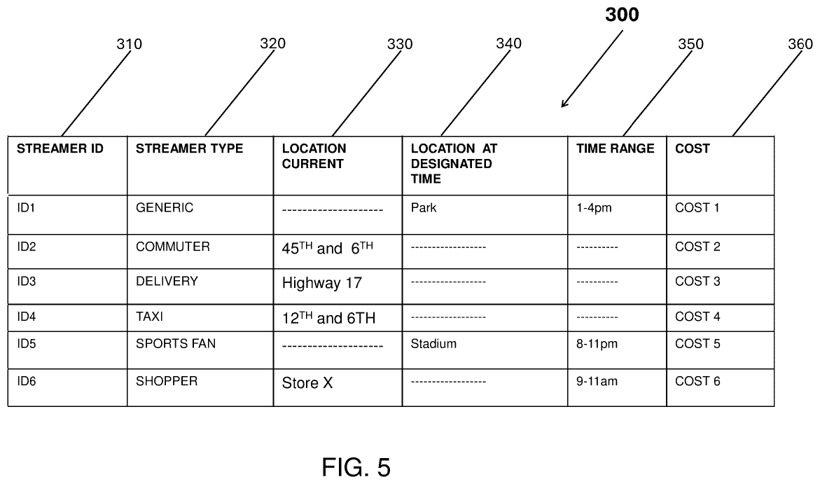

With referenced to FIG. 5, there is shown table which is part of a user interface 300 in embodiments of the invention. User interface 300 can include one or more of the shown columns. Streamers are listed in column 310. In column 310, streamers can be identified via a combination of one or more of a name, nick name, streamer ID number, thumbnail, and/or avatar. Column 320 lists a type or category of streamer. Different streamer types can include a generic streamer, that is available for POV streaming from a variety of locations or events. A commuter streamer is a streamer who may be driving or walking around a city or town during commuting or other times to stream and report on road conditions. So, for example, a user may select a commuter streamer to get a live point of view stream of traffic conditions in order to select a time or route for traveling.

A delivery category of streamer may be a driver for a food or package delivery service. This type of streamer can provide a POV stream of their location so that a user can obtain the location of their delivery driver. The user could also communicate with the driver to help guide them to a delivery location.

A taxi category of streamer could be a streamer that is providing a taxi or ride share service. In a manner similar to that of the delivery streamer discussed above, a user could access a POV stream from an approaching driver to determine how close the driver is, and the traffic conditions, to help estimate how close the driver is to the pickup point. In addition, the user could use the streaming service to help guide the taxi streamer to a pickup point. A sports fan category of streamer is a streamer that specializes in visiting sports events and streaming the events to users.

A shopper category of streamer is a streamer that specializes on assisting a user in shopping for items such as clothing, appliances, groceries or cars, by accessing stores in person and transmitting a POV stream to the user. Such a streamer helps a user view potential purchases without the user having to visit the store in person.

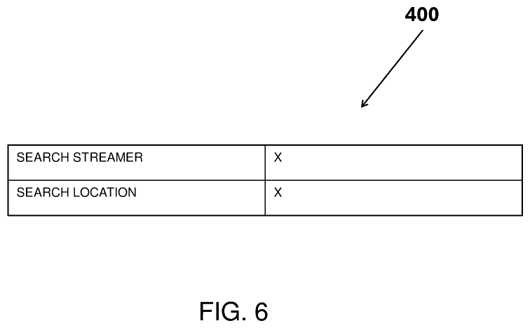

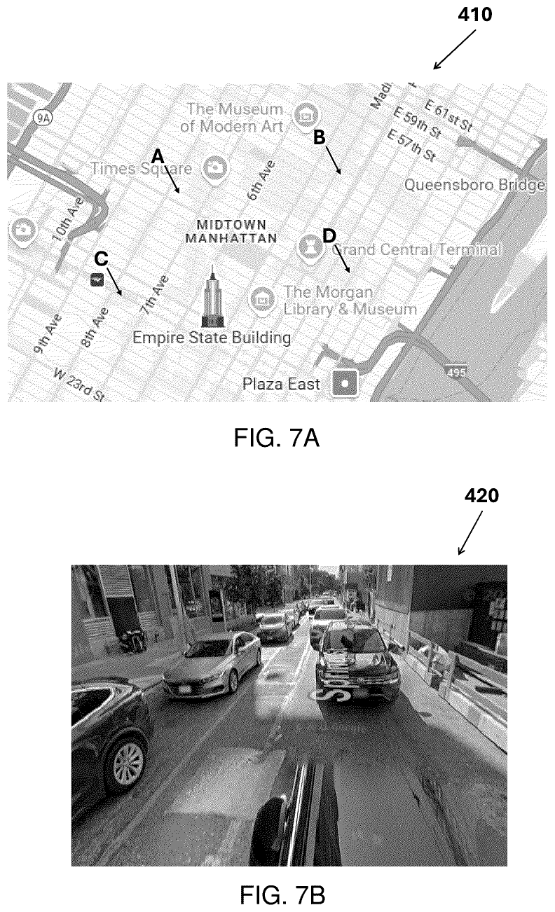

The current location column 330 provides information regarding the current location of a streamer, so that a user can select and access the streamer based on their current location. This process is described in further detail below with reference to FIGS. 6 and 7. Importantly, use of the current location feature employs a POV streaming instance instead of a specific event scheduled ahead at a predetermined, pre-arranged time. Instead, the user can select a stream for a streaming session based on a streamers location at a current time.

The location at a designated time column 340 also provides location information for the streamer. But instead of a current location, the location information is for a designated future time. For example, a streamer may indicate that they will be at a certain location at a specific time or time range indicted in column 350.

In addition, the cost column 360 indicates a cost for a specified event or streaming instance. Notably, a specific streamer may charge different rates that may vary based on multiple factors such as location, time, and type of activity.

In some embodiments, different versions of user interface 300 can be provided based on the type and/or preferences of a user. In some embodiments, a custom user interface 300 can be provided based on specific request by a user.

With reference to FIG. 6, there is shown a user interface 400 that allows a user to search for a streamer. Display of user interface 400 can be triggered by a user selecting a region in user interface 300. A user can select a streamer based on a streamer ID. Alternatively, a user can also search for a streamer based on a location of the streamer. In some embodiments, when the user enters a geographic location, a map can be displayed to show the location of one or more streamers located at or near the entered location.

FIGS. 7A and 7B are exemplary views of streamer search interfaces. FIG. 7A is a user interface 410 that displays a map that shows the location of various streamers A, B, C, D. In use, a user can select a streamer based on the streamer's location on a map. Upon selecting the streamer's location, the user can then see a POV view 720 from the streamer, as shown in FIG. 7B. While interface 410 can show a position of a streamer in real time, alternatively, interface 410 can show the position of a streamer at a certain pre-set time.

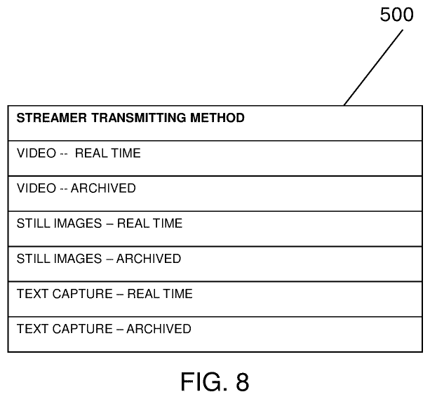

FIG. 8 is an exemplary view of a streamer POV transmitting method selection interface 500. In embodiments of the invention, the streamer can provide a representation of a POV event or scene via real time video, archived (i.e., previously recorded and stored) video, periodic real time transmission of still images, archived still images, real time text capture, and/or archived text capture. Display of interface 500 can be triggered by a user selection in user interface 300 or 400.

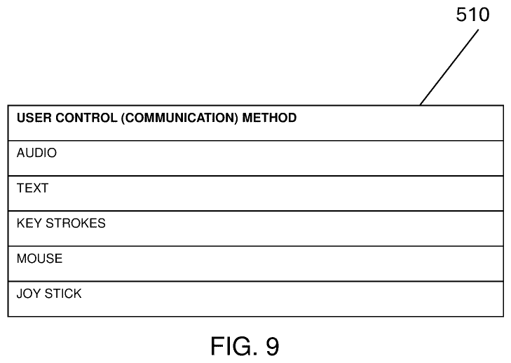

FIG. 9 illustrates a user control communication method selection interface 510. In embodiments of the invention, a user can select a method of controlling a streamer. The method of controlling a streamer can include one or more of audio communications, text communications, key strokes (e.g., up, down, left, right, arrows), and or a joy stick. In some embodiments, instead of a human streamer, the streamer can be in the form of a humanoid or other robot, or other robotic device. Display of interface 510 can be triggered by a user selection in user interface 300, 400 or 500.

While embodiments have been described with an arrangement where a streamer wears a head-mounted camera, in alternate embodiments, the POV streamed video could be provided by a handheld device, such as a camera or mobile phone, video adapted smart glasses, a chip implanted in the streamer, or a camera implanted in the eye of a streamer. In one implementation, network elements/devices can include software to achieve (or to foster) the activities discussed herein. This could include the implementation of instances of any of the components, engines, logic, etc. shown in the figures. Additionally, each of these devices can have an internal structure (e.g., a processor, a memory element, etc.) to facilitate some of the operations described herein. In other embodiments, these activities may be executed externally to these devices, or included in some other network element to achieve the intended functionality. Alternatively, these network devices may include software (or reciprocating software) that can coordinate with other network elements in order to achieve the management activities described herein. In still other embodiments, one or several devices may include any suitable algorithms, hardware, software, components, modules, interfaces, or objects that facilitate the operations thereof.

Note that with the example provided above, as well as numerous other examples provided herein, interaction may be described in terms of two, three, or four network elements. However, this has been done for purposes of clarity and example only. In certain cases, it may be easier to describe one or more of the functionalities of a given set of flows by only referencing a limited number of network elements. It should be appreciated that topologies illustrated in and described with reference to the accompanying figures (and their teachings) are readily scalable and can accommodate a large number of components, as well as more complicated/sophisticated arrangements and configurations. Accordingly, the examples provided should not limit the scope or inhibit the broad teachings of the illustrated topologies as potentially applied to a myriad of other architectures.

It is also important to note that the steps in the preceding flows illustrate only some of the possible signaling scenarios and patterns that may be executed by, or within, communication systems shown in the figures. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication systems shown in the figures in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. For example, although the present disclosure has been described with reference to particular communication exchanges, embodiments described herein may be applicable to other architectures.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method comprising:
selecting, from a first electronic device associated with a user, at a first remote location, a streamer displayed on the first electronic device, the streamer being available to capture a point-of-view (POV) video of a streaming session with a second electronic device;
connecting, from the first electronic device at the first remote location, to the second electronic device so that the second electronic device is selectively connected for direct audio and video communication to the first electronic device;
controlling, via the first electronic device at the first remote location, the streamer operating the second electronic device such that the streamer operates the second electronic device to capture the POV video at the streaming session;
wherein the selecting a streamer by the user includes:
viewing a map display indicating the locations of one or more streamers; and
selecting a streamer from the map display.

2. A method comprising:
selecting, from a first electronic device associated with a user, at a first remote location, a streamer from a table displayed on the first electronic device, the table comprising a list of streamers;
connecting, from the first electronic device at the first remote location, to the second electronic device so that the second electronic device is selectively connected for direct audio and video communication to the first electronic device;
controlling, via the first electronic device at the first remote location, the streamer operating the second electronic device such that the streamer operates the second electronic device to capture the POV video at the streaming session;
wherein the table displays:
a streamer ID of the streamer;
a current-time location of the streamer; and
a cost of the steaming session.

3. The method of claim 2, the table further displaying a streamer type category.

4. The method of claim 3, wherein the streamer type category is a commuter category, wherein the streamer provides a streaming session at a specific commuter location.

5. The method of claim 3, wherein the streamer type category is a taxi category, wherein the streamer provides a streaming session related to an approaching taxi service vehicle.

6. The method of claim 3, wherein the streamer type category is a delivery category, wherein the streamer provides a streaming session related to an approaching delivery vehicle.

7. The method of claim 2, further comprising:
in response to selection of the streamer, displaying a map that indicates the location of the streamer.

8. The method of claim 7, further comprising, in response to receiving a selection from the user, displaying a video stream of the streaming session.

9. The method of claim 7, further comprising, in response to receiving a selection from the user, displaying a video stream of the streaming session and simultaneously displaying the map.

10. A method comprising:
selecting, from a first electronic device associated with a user, at a first remote location, a streamer displayed on the first electronic device, the streamer being available to capture a point-of-view (POV) video of a streaming session with a second electronic device;
selecting, from a third electronic device associated with another user, at a second remote location, the streamer on the second electronic device, the streamer being available to capture a point-of-view (POV) video of a streaming session with the second electronic device;
connecting, from the first electronic device at the first remote location, to the second electronic device so that the second electronic device is selectively connected for direct audio and video communication to the first electronic device;
connecting, from the third electronic device at the second remote location, to the second electronic device so that the second electronic device is selectively connected for direct audio and video communication to the third electronic device;
controlling, via the first electronic device at the first remote location, the streamer operating the second electronic device such that the streamer operates the second electronic device to capture the POV video at the streaming session;
controlling, via the third electronic device at the second remote location, the streamer operating the second electronic device such that the streamer operates the second electronic device to capture the POV video at the streaming session;
wherein the selecting a streamer by the user and the another user includes:
viewing a map display indicating the locations of one or more streamers; and
selecting a streamer from the map display.

11. The method of claim 10, wherein
i) a first number of electronic devices are allowed to view the (POV) video of the reaming session,
ii) a few electronic devices of the first number of electronic devices are authorized to have direct audio communications with the streamer at the second electronic device during the streaming session, and
iii) control of the streamer via direct audio communication at the second electronic device is passed from the first electronic device to the third electronic device during the streaming session.

12. A first electronic device comprising:
a processor connected to a memory, the processor being configured to implement a process, the process including
receiving a selection, from the first electronic device associated with a user, at a first remote location, a streamer from a table displayed on the first electronic device, the table comprising a list of streamers;
connecting, from the first electronic device at the first remote location, to the second electronic device so that the second electronic device is selectively connected for direct audio and video communication to the first electronic device;
controlling, via the first electronic device at the first remote location, the streamer operating the second electronic device such that the streamer operates the second electronic device to capture the POV video at the streaming session;
wherein the table displays:
a streamer ID of the streamer;
a current-time location of the streamer; and
a cost of the steaming session.

13. The first electronic device of claim 12, the table further displaying a streamer type category.

14. The first electronic device of claim 13, wherein the streamer type category is a commuter category, wherein the streamer provides a streaming session at a specific commuter location.

15. The first electronic device of claim 13, wherein the streamer type category is a taxi category, wherein the streamer provides a streaming session related to an approaching taxi service vehicle.

16. The first electronic device of claim 13, wherein the streamer type category is a delivery category, wherein the streamer provides a streaming session related to an approaching delivery vehicle.
